(19) United States
(12) Patent Application Publication
(10) Pub. No.: US 2015/0268906 A1
(43) Pub. Date: Sep. 24, 2015

(54) COMMUNICATION APPARATUS, IMAGE FORMING APPARATUS, AND NON-TRANSITORY COMPUTER READABLE MEDIUM

(71) Applicant: FUJI XEROX CO., LTD., Tokyo (JP)

(72) Inventors: Satoshi KAMIYA, Kanagawa (JP); Chie OHARA, Kanagawa (JP); Hiromoto ANDO, Kanagawa (JP); Yoshimi UEZU, Kanagawa (JP)

(21) Appl. No.: 14/640,843

(22) Filed: Mar. 6, 2015

(30) Foreign Application Priority Data
Mar. 24, 2014 (JP) 2014-059949

(51) Int. Cl. G06F 3/12; G06Q 10/06; G06Q 30/04; H04N 1/32; H04N 1/00

(52) U.S. Cl. CPC G06F 3/1239; G06F 3/1285; H04N 1/32502; H04N 1/00408; G06Q 30/04; G06Q 10/06; H04N 1/00832; H04N 2201/0094

(57) ABSTRACT

A communication apparatus includes a communication unit, a first storage unit, a second storage unit, and a permitting unit. The communication unit communicates with a communication line for which a charge amount is changed in accordance with use of the communication line. The first storage unit stores operation information about an operational condition of the communication apparatus. The second storage unit stores charge information about the charge amount according to the use of the communication line. The permitting unit permits the communication unit to transmit the operation information, on the basis of a result obtained by comparing the charge information with predetermined charge limit information.

### CROSS-REFERENCE TO RELATED APPLICATIONS

This application is based on and claims priority under 35 USC 119 from Japanese Patent Application No. 2014-059949 filed Mar. 24, 2014.

### BACKGROUND

### Technical Field

The present invention relates to a communication apparatus, an image forming apparatus, and a non-transitory computer readable medium.

### SUMMARY

According to an aspect of the invention, there is provided a communication apparatus including a communication unit, a first storage unit, a second storage unit, and a permitting unit. The communication unit communicates with a communication line for which a charge amount is changed in accordance with use of the communication line. The first storage unit stores operation information about an operational condition of the communication apparatus. The second storage unit stores charge information about the charge amount according to the use of the communication line.

The permitting unit permits the communication unit to transmit the operation information on the basis of a result obtained by comparing the charge information with predetermined charge limit information.

### BRIEF DESCRIPTION OF THE DRAWINGS

Exemplary embodiments of the present invention will be described in detail based on the following figures, wherein:

FIG. 1 is a diagram illustrating the overall configuration of a system;

FIG. 2 is a diagram illustrating a functional configuration of an image forming apparatus;

FIG. 3 is a diagram illustrating a functional configuration of the image forming apparatus;

FIG. 4 is a diagram illustrating a functional configuration of the image forming apparatus;

FIG. 5 is a diagram illustrating the hardware configuration of the image forming apparatus;

FIG. 6 is a diagram illustrating exemplary schedule information;

FIG. 7 is a flowchart of an irregular transmission process performed by the image forming apparatus; and

FIG. 8 is a diagram illustrating an exemplary traffic volume table.

### DETAILED DESCRIPTION

### 1. Configuration

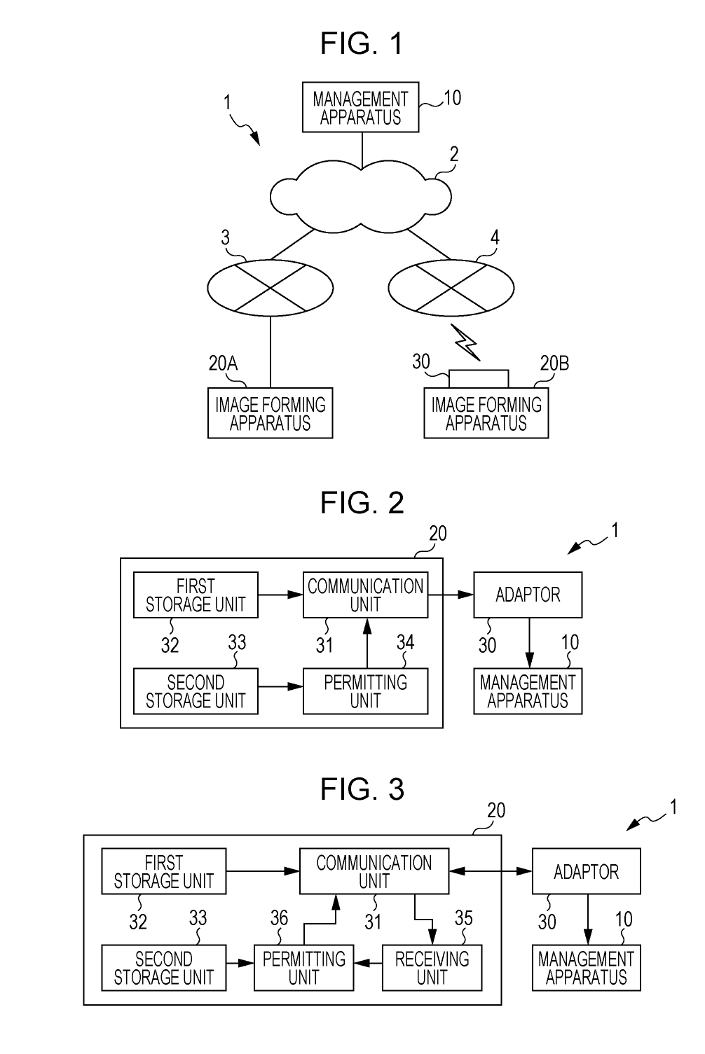

FIG. 1 is a diagram illustrating the overall configuration of a system 1 according to the present exemplary embodiment. The system 1 includes a management apparatus 10 and image forming apparatuses 20A and 20B. The image forming apparatuses 20A and 20B are, for example, electrophotographic image forming apparatuses. The image forming apparatuses 20A and 20B are provided with an image forming function for forming an image on a recording medium such as a sheet of paper, a copying function of copying an image, a scan function of reading an image formed on a recording medium, or the like. The functions provided for the image forming apparatuses 20A and 20B are not limited to these functions, and, for example, a facsimile function may be provided. The image forming apparatuses 20A and 20B are not limited to those provided with all of the above-described functions, and may have a configuration, for example, in which the image forming function and the copying function are provided and in which the other functions are not provided. In description below, when the image forming apparatuses 20A and 20B do not need to be identified, they are collectively called “image forming apparatuses 20”.

The management apparatus 10 is an apparatus for maintaining and managing the image forming apparatuses 20. The management apparatus 10 regularly and irregularly receives operation information about the operational conditions of an image forming apparatus 20 (such as the value of a billing meter, a remaining amount of a consumable article, and an error history). The management apparatus 10 accumulates the operation information transmitted from the image forming apparatus 20. On the basis of the accumulated operation information, the management apparatus 10, for example, performs the following processes: a process of submitting a bill; a process of estimating the life of a consumable article, and distributing the consumable article when the end of the life is coming; and a process necessary for various types of maintenance.

A network 2 is a communication network such as the Internet. A network 3 which is a communication network such as a local area network (LAN) is constructed in an environment in which the image forming apparatus 20A is installed. The management apparatus 10 is connected to the image forming apparatus 20A over the network 2 and the network 3. The image forming apparatus 20A may be directly connected to the network 2 without connection via the network 3. A mobile communication network 4 is a communication network which includes multiple base stations and which uses wireless communication between a base station and a mobile terminal. An adaptor 30 is an adaptor for connecting the image forming apparatus 20B to the mobile communication network 4, and is used by mounting the adaptor 30 on the image forming apparatus 20B. The image forming apparatus 20B is connected to the mobile communication network 4 through wireless communication via the adaptor 30.

FIG. 2 is a diagram illustrating a functional configuration of an image forming apparatus 20. The image forming apparatus 20 includes a communication unit 31, a first storage unit 32, a second storage unit 33, and a permitting unit 34. The communication unit 31 communicates with a communication line for which the charge amount is changed in accordance with the use. The first storage unit 32 stores the operation information about the operational conditions of the image forming apparatus 20. The second storage unit 33 stores charge information about the amount of charge imposed for use of the communication line. The permitting unit 34 permits the communication unit 31 to transmit the operation information, on the basis of the result of comparison between the charge information and predetermined charge limit information.

FIG. 3 is a diagram illustrating another functional configuration of the image forming apparatus 20. In this example, the image forming apparatus 20 includes the communication unit 31, the first storage unit 32, the second storage unit 33, a receiving unit 35, and a permitting unit 36. Among these units, the communication unit 31, the first storage unit 32, and the second storage unit 33 are similar to those illustrated in FIG. 2. The receiving unit 35 determines reception of a permission signal from the communication unit 31. In the case where the charge amount indicated by the charge information exceeds a predetermined charge limit, after a permission signal is received, the permitting unit 36 permits the communication unit 31 to transmit the operation information.

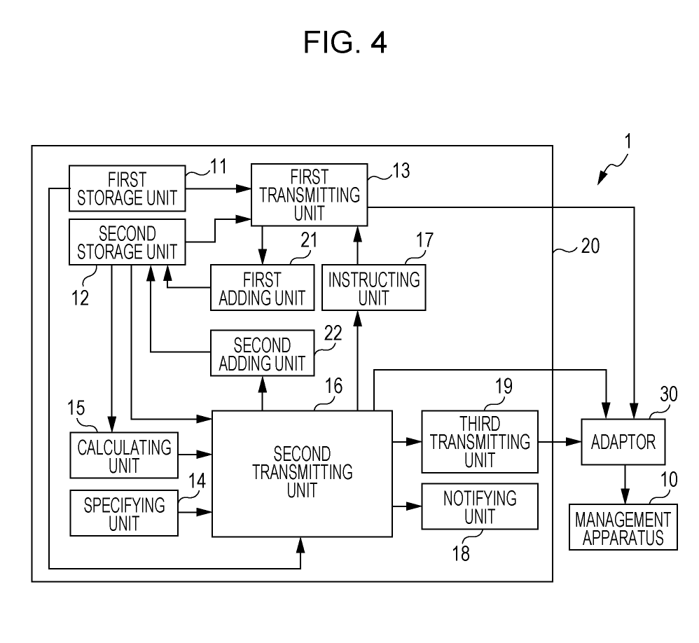

FIG. 4 is a diagram illustrating yet another functional configuration of the image forming apparatus 20. In this example, the image forming apparatus 20 includes a first storage unit 11, a second storage unit 12, a first transmitting unit 13, a specifying unit 14, a calculating unit 15, a second transmitting unit 16, an instructing unit 17, a notifying unit 18, a third transmitting unit 19, a first adding unit 21, and a second adding unit 22. The first storage unit 11 stores the operation information about the operational conditions of the image forming apparatus 20. The second storage unit 12 stores schedule information indicating a schedule, according to which the operation information is transmitted to the management apparatus 10, upper-limit traffic volume which indicates an upper-limit traffic volume available in a predetermined unit period, and the cumulative traffic volume used from the start date and time of the unit time to the current date and time.

The first transmitting unit 13 transmits the operation information to the management apparatus 10 according to the schedule indicated by the schedule information stored in the second storage unit 12. When a period from the latest timing at which the operation information was transmitted by the second transmitting unit 16 to a transmission timing according to the schedule indicated by the schedule information is equal to or less than a predetermined period, the first transmitting unit 13 does not transmit the operation information at the transmission timing. The first adding unit 21 adds the traffic volume used in transmission performed by the first transmitting unit 13 to the cumulative traffic volume stored in the second storage unit 12. In this example, the volume of traffic is the volume of data or the time for communication.

When an instruction to transmit the operation information is supplied at a timing different from a timing according to the schedule indicated by the schedule information stored in the second storage unit 12, the specifying unit 14 specifies the traffic volume which may be to be used for the transmission. The calculating unit 15 calculates the scheduled traffic volume which may be to be used for the case in which the operation information is transmitted according to the schedule indicated by the schedule information from the current date and time to the end date and time of the unit time.

When a subtraction result obtained by subtracting the cumulative traffic volume and the scheduled traffic volume which are stored in the second storage unit 12 from the upper-limit traffic volume stored in the second storage unit 12 is equal to or more than the traffic volume specified by the specifying unit 14, the second transmitting unit 16 transmits the operation information whose transmission is specified in the instruction, to the management apparatus 10. The second adding unit 22 adds the traffic volume used in transmission performed by the second transmitting unit 16 to the cumulative traffic volume stored in the second storage unit 12.

When the subtraction result of the subtraction process performed by the second transmitting unit 16 is less than the traffic volume specified by the specifying unit 14, the instructing unit 17 instructs the first transmitting unit 13 to stop transmission of the operation information at one or more timings according to the schedule indicated by the schedule information stored in the second storage unit 12.

When the subtraction result of the subtraction process performed by the second transmitting unit 16 is less than the traffic volume specified by the specifying unit 14, the notifying unit 18 notifies a user that the transmission of operation information which is specified in the instruction will incur an additional charge. When the subtraction result of the subtraction process performed by the second transmitting unit 16 is less than the traffic volume specified by the specifying unit 14, the third transmitting unit 19 transmits information indicating that the transmission of operation information which is specified in the instruction will incur an additional charge, to the management apparatus 10.

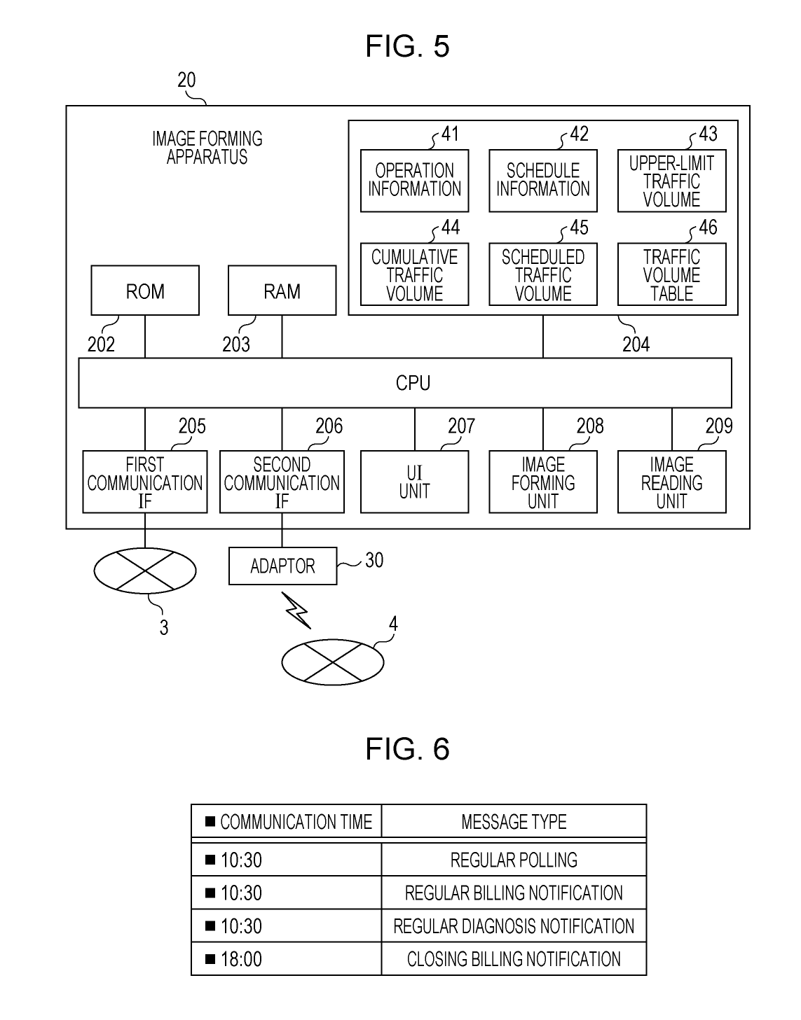

FIG. 5 is a diagram illustrating an exemplary hardware configuration of the image forming apparatus 20. The image forming apparatus 20 includes a central processing unit (CPU) 201, a read only memory (ROM) 202, a random access memory (RAM) 203, a storage 204, a first communication interface (IF) 205, a second communication IF 206, a user interface (UI) unit 207, an image forming unit 208, and an image reading unit 209. The CPU 201 is a control apparatus (processor) which controls units of the image forming apparatus 20. The ROM 202 is a nonvolatile storage apparatus which stores programs and data. The RAM 203 is a volatile main storage which functions as a work area when the CPU 201 executes the programs. The storage 204 is a nonvolatile auxiliary storage which stores programs and data. The first communication IF 205 is an interface for performing communication via the network 3. Especially in this example, the first communication IF 205 is an interface for communicating with the management apparatus 10 via the network 3. The second communication IF 206 on which the adaptor 30 is mounted is an interface for performing communication via the adaptor 30 and the mobile communication network 4. Especially in this example, the second communication IF 206 is an interface for communicating with the management apparatus 10 via the adaptor 30 and the mobile communication network 4.

The UI unit 207 provided with operators, such as various keys and a touch sensor, supplies information about user operations to the CPU 201. The CPU 201 performs processes in accordance with the information about user operations. The UI unit 207 is provided with a liquid-crystal panel and a liquid-crystal driving circuit, and displays an image under the control of the CPU 201. The image forming unit 208 forms an image on a recording medium such as a sheet of paper by using an electrophotographic system. The image reading unit 209 optically reads an image of a document.

In this example, the CPU 201 executes the programs for transmitting operation information which are stored in the storage 204 (or the ROM 202), whereby the functions illustrated in FIG. 2, 3, or 4 are achieved. The storage 204 is an example of the first storage unit 32, the second storage unit 33, the first storage unit 11, and the second storage unit 12. The CPU 201 which executes the programs for transmitting operation information, the second communication IF 206, or the CPU 201 and the second communication IF 206 are an example of the communication unit 31, the first transmitting unit 13, the second transmitting unit 16, and the third transmitting unit 19. The CPU 201 which executes the programs for transmitting operation information is an example of the permitting unit 34, the receiving unit 35, the permitting unit 36, the specifying unit 14, the calculating unit 15, the instructing unit 17, the notifying unit 18, the first adding unit 21, and the second adding unit 22. Detailed description about the hardware configuration of the management apparatus 10 will be skipped. The management apparatus 10 is a computer including a CPU, a ROM, a RAM, a storage, and a communication interface.

When the environment in which an image forming apparatus 20 is installed is an environment connectable to the network 3 such as a LAN, the image forming apparatus 20 is connected to the network 3 by using the first communication IF 205. In this case, the image forming apparatus 20 communicates with the management apparatus 10 via the network 3. In contrast, the image forming apparatus 20 is occasionally not installed in an environment connectable to the network 3, or the image forming apparatus 20 is occasionally not allowed to be connected to the network 3 due to concerns about security. In this case, it is impossible to connect the image forming apparatus 20 to the network 3 by using the first communication IF 205. In this example, when it is impossible to connect the image forming apparatus 20 to the network 3, the adaptor 30 is mounted on the second communication IF 206 of the image forming apparatus 20, and the mobile communication network 4 is used to connect the image forming apparatus 20 to the management apparatus 10.

Thus, when the mobile communication network 4 is used for the image forming apparatus 20 to communicate with the management apparatus 10, unlike communication via the network 3, charge according to the traffic volume (the volume of data or the time for communication) which is used may be imposed. For example, a billing system may be employed in which the monthly upper limit of traffic volume is determined and in which, when the traffic volume exceeds the upper limit, additional charge is imposed. Thus, in a billing system in which, when the traffic volume exceeds the upper limit, additional charge is imposed, the larger the traffic volume is, the larger the charge amount is. Therefore, the traffic volume may be desirably reduced down to an amount equal to or less than the upper limit as much as possible. In the exemplary embodiment, when the operation information is to be transmitted, processes described below are performed, suppressing occurrence of the state in which the traffic volume exceeds the upper limit. In the exemplary embodiment, the traffic volume is the volume of data or the time for communication. Whether the volume of data or the time for communication is to be used as the traffic volume is determined in accordance with a predetermined condition (such as the contract of each of users and/or a time period).

### 2. Operations

Operations of transmitting operation information which are performed by an image forming apparatus 20 will be described. The operation information transmitted by the image forming apparatus 20 includes various types of information about the operational conditions of the image forming apparatus 20, such as an output value of a sensor detecting the remaining amount of toner, the number of rotations of a photoconductor drum, and a history of errors occurring in the process of forming an image. In this example, operations of transmitting operation information which are performed by the image forming apparatus 20 are classified into two types, “regular transmission” and “irregular transmission”. The type “regular transmission” indicates that the operation information is transmitted according to a predetermined schedule at predetermined timings determined in the schedule. In contrast, the type “irregular transmission” indicates that the operation information is transmitted at a timing different from the timings determined by the schedule. Examples of a timing at which “irregular transmission” is performed include a case in which a user of the image forming apparatus 20 (for example, an administrator of the image forming apparatus 20) uses the UI unit 207 to supply an instruction to transmit the operation information, a case in which a specific error occurs in the image forming apparatus 20, and a case in which an instruction to transmit the operation information is received from the management apparatus 10.

In the process of transmitting operation information, various types of information stored in the storage 204 are used. As illustrated in FIG. 5, the storage 204 stores operation information 41, schedule information 42, upper-limit traffic volume 43, cumulative traffic volume 44, scheduled traffic volume 45, and a traffic volume table 46. The operation information 41 is information about the operational conditions of an image forming apparatus 20, and includes information, such as the output value of a sensor detecting the remaining amount of toner, the number of rotations of a photoconductor drum, and a history of errors occurring in the process of forming an image, as described above. The operation information 41 may include charge information according to use of the image forming apparatus 20. The information indicating the output value of a sensor, a history of errors, and the like is sequentially accumulated as the operation information 41 in the storage 204.

The schedule information 42 is information representing a schedule for regular transmission of the operation information 41. The CPU 201 of the image forming apparatus 20 performs regular transmission of the operation information according to the schedule indicated by the schedule information 42. The upper-limit traffic volume 43 indicates the upper limit of traffic volume of the mobile communication network 4 which is available in a predetermined unit period. In this example, the user of the image forming apparatus 20 signs, for example, a monthly contract for use of the mobile communication network 4. In this example, a monthly upper limit of the traffic volume (the volume of data or the time for communication) of the mobile communication network 4 is provided, and the upper-limit traffic volume 43 represents this upper limit. In this example, when the monthly traffic volume exceeds the upper-limit traffic volume 43, additional charge will be imposed.

The cumulative traffic volume 44 indicates a cumulative value of the traffic volume in a predetermined unit period. In this example, the cumulative traffic volume 44 indicates a cumulative monthly value of the traffic volume till the current time point. Every time a predetermined unit period is ended (such as the closing date at the end of a month), the cumulative traffic volume 44 is reset. The scheduled traffic volume 45 indicates a traffic volume which may be to be used in regular transmission of the operation information according to the schedule indicated by the schedule information from the current date and time to the end date and time of the predetermined unit time. In this example, the scheduled traffic volume 45 indicates a traffic volume which may be to be used in regular transmission from the current time point to the closing date at the end of the month. The traffic volume table 46 is a table in which the traffic volume (the volume of data and/or the time for communication) is stored for each of the types of operation information to be transmitted. The CPU 201 refers to the traffic volume table 46 when the scheduled traffic volume 45 is to be calculated. In the case where an instruction to perform irregular transmission is supplied, when the CPU 201 is to estimate a traffic volume which may be to be used in the irregular transmission, the traffic volume table 46 is referred to. The CPU 201 uses these pieces of information stored in the storage 204 to perform a regular transmission process and an irregular transmission process described below.

### 2-1. Regular Transmission

The process of performing regular transmission of the operation information 41 which is performed by the CPU 201 will be described. The CPU 201 performs regular transmission of the operation information 41 according to the schedule indicated by the schedule information 42 stored in the storage 204. In addition, the CPU 201 adds a traffic volume used in the regular transmission to the cumulative traffic volume 44.

FIG. 6 is a diagram illustrating exemplary schedule information 42. In the example illustrated in FIG. 6, items, “communication time” and “message type”, are associated with each other in the schedule information. The item “communication time” indicates time to perform regular transmission. The item “message type” indicates either of types, “regular polling”, “regular billing notification”, “regular diagnosis notification”, and “closing billing notification”. The type “regular polling” indicates that an inquiry is transmitted to the management apparatus 10 at predetermined time (10:30). In this example, the CPU 201 of the image forming apparatus 20 transmits an inquiry about whether or not any instruction is present, to the management apparatus 10 at 10:30. In “regular polling”, the operation information is not transmitted. However, in the exemplary embodiment, description will be made under the assumption that “regular polling” is encompassed in “regular transmission”.

The type “regular billing notification” indicates that the management apparatus 10 is notified of the operation information such as a charge amount for use of the image forming apparatus 20 or the like at predetermined time (10:30). The type “regular diagnosis notification” indicates that the management apparatus 10 is notified of the operation information about the process of forming an image which is performed by the image forming apparatus 20 (such as the number of rotations of a drum and a detected value of the remaining amount of toner) at predetermined time (10:30). In this example, the CPU 201 transmits the operation information 41 accumulated in the storage 204 to the management apparatus 10 at 10:30. The type “closing billing notification” indicates that the charge information indicating a charge amount or the like is transmitted at predetermined time (18:00). In this example, the CPU 201 transmits the charge information included in the operation information 41 accumulated in the storage 204 to the management apparatus 10 at 18:00.

### 2-2. Irregular Transmission

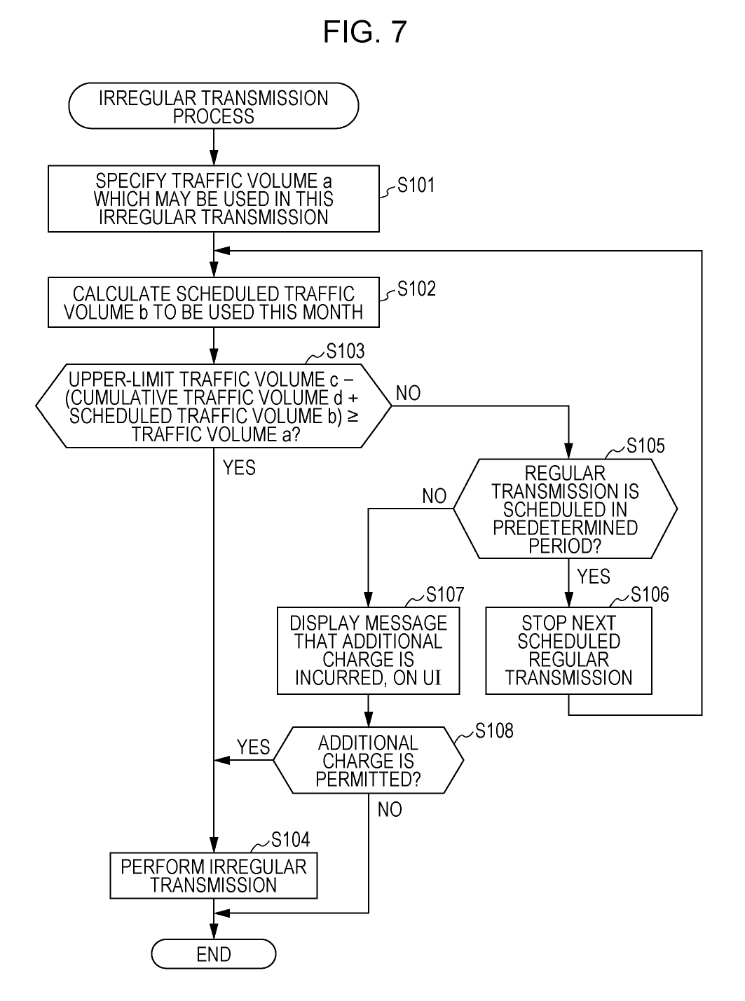

FIG. 7 is a flowchart of an irregular transmission process which is performed by the image forming apparatus 20. This flow is performed by using an instruction that the image forming apparatus 20 perform irregular transmission, as a trigger. In this example, examples of a case in which an instruction to perform irregular transmission is supplied include a case in which a user of the image forming apparatus 20 uses the UI unit 207 to supply an instruction to perform irregular transmission, a case in which a specific error occurs in the image forming apparatus 20, and a case in which a response indicating that irregular transmission is to be performed is received as a response to the request which has been transmitted by the image forming apparatus 20 in the “regular polling” described above.

In step S101, the CPU 201 refers to the traffic volume table 46 to specify the traffic volume (hereinafter referred to as a “traffic volume a”) which may be to be used in irregular transmission performed this time. The process of specifying the traffic volume is performed on the basis of the type of operation information which needs to be transmitted in this irregular transmission. The operation information which needs to be transmitted is specified on the basis of the instruction to perform this irregular transmission.

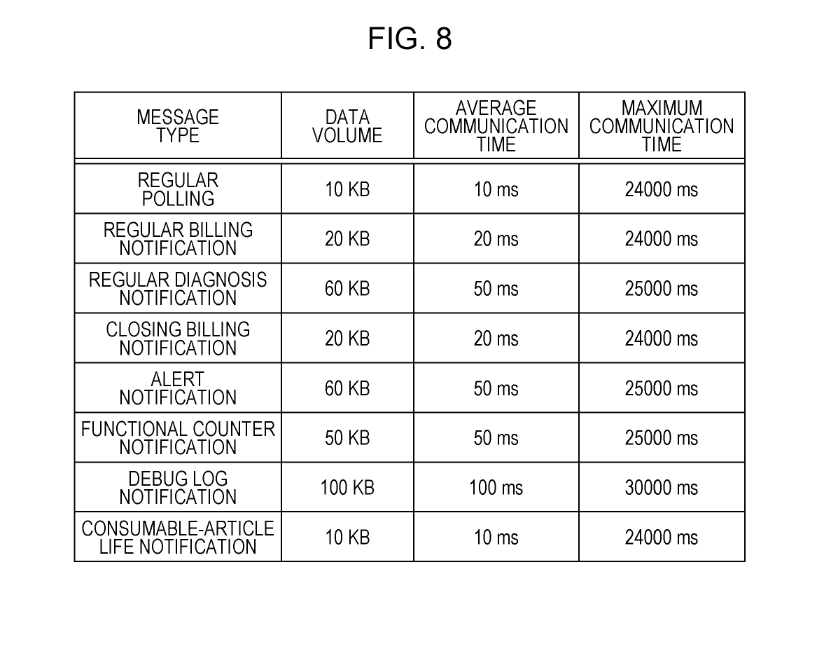

FIG. 8 is a diagram illustrating an exemplary traffic volume table 46. In this example, items, “message type”, “data volume”, “average communication time”, and “maximum communication time”, are stored in association with one another in the traffic volume table 46. Among these items, the item “message type” indicates either of message types, “regular polling”, “regular billing notification”, “regular diagnosis notification”, “closing billing notification”, “alert notification”, “functional counter notification”, “debug log notification”, and “consumable-article life notification”. Among these message types, “regular polling”, “regular billing notification”, “regular diagnosis notification”, and “closing billing notification” are similar to those illustrated in FIG. 6. The message type “alert notification” indicates that the image forming apparatus 20 notifies the management apparatus 10 of a predetermined alert. The message type “functional counter notification” indicates that a measured value for a predetermined function is transmitted. The message type “debug log notification” indicates that logs which are accumulated in the image forming apparatus 20 so as to perform debugging are transmitted to the management apparatus 10. The message type “consumable-article life notification” indicates that information indicating the life of a consumable article is transmitted to the management apparatus 10.

The item “data volume” in FIG. 8 stores the volume of data to be transmitted. The item “average communication time” stores the average communication time required for transmission of the data. The item “maximum communication time” stores the maximum communication time required for transmission of the data. In the instruction to perform irregular transmission, either of the message types illustrated in FIG. 8 is specified. The CPU 201 selects whether the volume of data or the time for communication is used as the traffic volume, on the basis of a predetermined condition such as a contract condition. The CPU 201 refers to the traffic volume table 46 to specify the traffic volume which may be to be used for the irregular transmission on the basis of the selected type of traffic volume corresponding to the specified notification type. In this example, when the volume of data is selected as the traffic volume, the CPU 201 specifies the data volume corresponding to the notification type of the irregular transmission, as the traffic volume. In contrast, when the time for communication is selected as the traffic volume, the CPU 201 specifies the average communication time corresponding to the notification type of the irregular transmission, as the traffic volume. The CPU 201 may specify the maximum communication time corresponding to the type of the irregular transmission, as the traffic volume.

In step S102, the CPU 201 calculates the scheduled traffic volume 45 (hereinafter referred to as a “scheduled traffic volume b”) on the basis of the schedule information 42 stored in the storage 204. The timing at which the process of calculating a scheduled traffic volume b is performed is not limited to a timing after step S101. For example, the CPU 201 may calculate a scheduled traffic volume b every time regular transmission is performed, and may store the calculation result in the storage 204 at that time.

In step S103, the CPU 201 compares a subtraction result e with the traffic volume a. The subtraction result e is obtained by subtracting the cumulative traffic volume 44 (hereinafter referred to as a “cumulative traffic volume d”) and the scheduled traffic volume b from the upper-limit traffic volume 43 (hereinafter referred to as an “upper-limit traffic volume c”). If the subtraction result e is equal to or more than the traffic volume a, no additional charge will be incurred even when the irregular transmission is performed. Therefore, if the subtraction result e is equal to or more than the traffic volume a (YES in step S103), the CPU 201 proceeds to step S104, and performs the irregular transmission specified in the instruction. In step S104, the CPU 201 may compress data to be transmitted and may transmit it. After the irregular transmission, the CPU 201 adds the traffic volume used in the irregular transmission to the cumulative traffic volume d.

In step S103, if the subtraction result e is less than the traffic volume a (NO in step S103), the CPU 201 proceeds to step S105. In step S105, the CPU 201 determines whether or not a regular transmission is scheduled in a predetermined period starting from the current time, on the basis of the schedule information 42. If a regular transmission is scheduled in the predetermined period (YES in step S105), the CPU 201 proceeds to step S106.

In step S106, the CPU 201 adds information indicating an instruction to stop the next scheduled regular transmission, to the schedule information 42 stored in the storage 204. The schedule information 42 is referred to when the next regular transmission is to be performed. When the schedule information 42 includes information indicating an instruction to stop the transmission, the CPU 201 does not perform the regular transmission.

When the process in step S106 is completed, the CPU 201 returns back to step S102. That is, the CPU 201 calculates a scheduled traffic volume b again for the case in which the next regular transmission is stopped, again in step S102, and performs subtraction on the basis of the calculated scheduled traffic volume b in step S103. Then, the CPU 201 compares the subtraction result e with the traffic volume a again. If the cancel of the next regular transmission causes the subtraction result e to be equal to or more than the traffic volume a, the CPU 201 proceeds to step S104, and performs irregular transmission. In contrast, in step S103, if the subtraction result e is still less than the traffic volume a, the CPU 201 proceeds to step S105 again, and determines whether or not a regular transmission other than the regular transmission which has been stopped is scheduled in the predetermined period. If a regular transmission other than the regular transmission which has been stopped is scheduled in the predetermined period, the CPU 201 proceeds to step S106, and adds information indicating an instruction to stop the next regular transmission scheduled in the predetermined period, to the schedule information 42 stored in the storage 204. If multiple regular transmissions are scheduled to be performed in the predetermined period, the CPU 201 repeatedly performs the processes in steps S102, S103, S105, and S106 until the subtraction result e is equal to or more than the traffic volume a.

In step S105, if it is determined that no regular transmissions are scheduled in the predetermined period (NO in step S105), the CPU 201 proceeds to step S107. In step S107, the CPU 201 causes the UI unit 207 to display a message that the irregular transmission is to incur an additional charge, thereby notifying the user that an additional charge is to be incurred. At that time, the CPU 201 also causes the UI unit 207 to display a screen for selecting whether or not the additional charge is permitted.

The user of the image forming apparatus 20 checks the screen displayed on the UI unit 207, and performs an operation for selecting whether or not the additional charge is permitted. The UI unit 207 outputs information according to the operation performed by the user to the CPU 201. In step S108, the CPU 201 determines whether or not the additional charge is to be incurred, on the basis of the information outputted from the UI unit 207. At that time, in the case where the selection operation is not performed on the UI unit 207 even when a predetermined period has elapsed, the CPU 201 may determine that the additional charge is not permitted. If it is determined that the additional charge is permitted (YES in step S108), the CPU 201 proceeds to step S104, and performs irregular transmission of the operation information. If it is determined that no additional charge is permitted (NO in step S108), the CPU 201 skips step S104, and ends the process. That is, if it is determined that no additional charge is permitted, the irregular transmission of the operation information which is specified in the instruction is not performed.

In the exemplary embodiment, when an instruction to perform irregular transmission is supplied, the CPU 201 compares the traffic volume a which may be to be used in the irregular transmission with the subtraction result e indicating the remaining traffic volume available without additional charge. When the remaining traffic volume is less than the traffic volume a, the CPU 201 performs the process for limiting regular transmission. Thus, occurrence of additional charge is suppressed.

### 3. Modified Exemplary Embodiments

The above-described exemplary embodiments are an example of the present invention. These exemplary embodiments may be modified as described below. The modified exemplary embodiments described below may be combined with one another.

### 3-1. First Exemplary Embodiment

The system 1 according to the above-described exemplary embodiments includes the management apparatus 10 and the image forming apparatus 20A and 20B. The number of management apparatuses 10 and that of image forming apparatuses 20 are not limited to those in the system 1.

### 3-2. Second Exemplary Embodiment

In the above-described exemplary embodiments, after irregular transmission is performed in step S104 in FIG. 7, the CPU 201 compares the current time with the time at which the next regular transmission is scheduled to be performed. When the difference between the two times is equal to or less than a predetermined time period, the CPU 201 may stop the next regular transmission. In other words, when a period from a timing at which the operation information was transmitted in the latest irregular transmission to the transmission timing of the next regular transmission is equal to or less than the predetermined period, the CPU 201 may stop the next regular transmission. In particular, if the difference between the time at which the latest irregular transmission was performed and the time at which the next regular transmission is scheduled to be performed is equal to or less than the predetermined threshold, and if the difference between the operation information transmitted in the latest irregular transmission and the operation information scheduled to be transmitted in the next regular transmission is less than a predetermined value, the CPU 201 may stop the next regular transmission.

### 3-3. Third Exemplary Embodiment

In the above-described exemplary embodiments, in step S105 in FIG. 7, the CPU 201 determines whether or not a regular transmission is scheduled in the predetermined period. The CPU 201 may skip step S105. In this case, regardless of whether or not the next regular transmission is scheduled in the predetermined period, the CPU 201 stops the next regular transmission.

### 3-4. Fourth Exemplary Embodiment

In the above-described exemplary embodiments, in step S107 in FIG. 7, the CPU 201 causes the UI unit 207 to display a message that an additional charge is to be incurred, thereby notifying a user of this message. The notification method is not limited to this. For example, the image forming apparatus 20 may be provided with a speaker, and the CPU 201 may cause the speaker to output a voice message that an additional charge is to be incurred or warning sound, thereby achieving notification. As another example, the CPU 201 may transmit a mail describing that an additional charge is to be incurred, for example, to a predetermined mail address. In short, the CPU 201 may notify a user in some way.

Instead of step S107, the CPU 201 may transmit data indicating that an additional charge is to be incurred to the management apparatus 10. The CPU 201 may perform step S107 and may also transmit data indicating that an additional charge is to be incurred to the management apparatus 10.

In the above-described exemplary embodiments, in step S108 in FIG. 7, the CPU 201 causes the UI unit 207 to display a screen in which a user selects whether or not an additional charge is to be permitted. The method of determining whether or not an additional charge is to be permitted is not limited to this. For example, instead of step S108, the CPU 201 may transmit data indicating an inquiry about whether or not an additional charge is to be permitted to the management apparatus 10. After data indicating permission (permission signal) is received from the management apparatus 10, the CPU 201 may permit irregular transmission of the operation information.

### 3-5. Fifth Exemplary Embodiment

In the above-described exemplary embodiments, in step S106 in FIG. 7, the CPU 201 stops the next regular transmission. Instead, the CPU 201 may specify the number of regular transmissions to be stopped, on the basis of the traffic volume a, and may stop the regular transmissions, the number of which is equal to the specified number. In the above-described exemplary embodiments, after the CPU 201 performs step S106, the CPU 201 returns back to step S102, and performs the process of calculating a scheduled traffic volume b and the determination process in step S103 again. After step S106 is performed, instead of returning back to step S102, the CPU 201 may proceed to step S104, and may perform irregular transmission. In this case, the irregular transmission may cause an additional charge to be incurred. Compared with the case in which step S106 is not performed, the additional charge amount is suppressed.

In the above-described exemplary embodiments, when the CPU 201 is to perform regular transmission according to the schedule information, the CPU 201 may determine whether or not the operation information to be transmitted in the regular transmission is included in the operation information transmitted in the latest irregular transmission. In the case where the operation information is already transmitted in the latest irregular transmission, only when the operation information is updated, the CPU 201 may perform regular transmission. In this case, the CPU 201 determines whether or not the operation information transmitted in the latest irregular transmission is updated. When the operation information is not updated, the CPU 201 stops the regular transmission. In this case, for example, a configuration may be employed in which the storage 104 stores a flag indicating whether or not the operation information is updated after an irregular transmission, and the CPU 201 may refer to the flag value to determine whether or not the operation information is updated.

### 3-6. Sixth Exemplary Embodiment

In the above-described exemplary embodiments, a program executed by the CPU 201 of the image forming apparatus 20 may be downloaded through a communication line such as the Internet. This program may be supplied by recording it in a computer-readable recording medium, such as a magnetic recording medium (such as a magnetic tape or a magnetic disk), an optical recording medium (such as an optical disk), a magneto-optical recording medium, or a semiconductor memory.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A communication apparatus comprising:
a communication unit that communicates with a communication line for which a charge amount is changed in accordance with use of the communication line;
a first storage unit that stores operation information about an operational condition of the communication apparatus;
a second storage unit that stores charge information about the charge amount according to the use of the communication line; and
a permitting unit that permits the communication unit to transmit the operation information on a basis of a result obtained by comparing the charge information with predetermined charge limit information.

2. A communication apparatus comprising:
a communication unit that communicates with a communication line for which a charge amount is changed in accordance with use of the communication line;
a first storage unit that stores operation information about an operational condition of the communication apparatus;
a second storage unit that stores charge information about the charge amount according to the use of the communication line;
a receiving unit that determines reception of a permission signal from the communication unit; and
a permitting unit that, in the case where the charge information exceeds a predetermined charge limit, after the permission signal is received, permits the communication unit to transmit the operation information.

3. A communication apparatus comprising:
a first storage unit that stores operation information about an operational condition of the communication apparatus;
a second storage unit that stores schedule information indicating a schedule for transmitting the operation information, an upper-limit traffic volume indicating an upper limit of traffic volume available in a predetermined unit period, and a cumulative traffic volume used from a start date and time of the unit period to a current date and time;
a first transmitting unit that transmits the operation information to a management apparatus according to the schedule indicated by the schedule information;
a first adding unit that adds a traffic volume used by the first transmitting unit, to the cumulative traffic volume;
a specifying unit that, when an instruction is supplied to transmit the operation information at a timing different from the schedule indicated by the schedule information, specifies a traffic volume to be used in the transmission;
a calculating unit that calculates a scheduled traffic volume scheduled to be used in the case where the operation information is transmitted in a period from the current date and time to an end date and time of the unit period according to the schedule indicated by the schedule information;
a second transmitting unit that, when a subtraction result obtained by subtracting the cumulative traffic volume and the scheduled traffic volume from the upper-limit traffic volume is equal to or more than the specified traffic volume, transmits the operation information whose transmission is specified in the instruction, to the management apparatus; and
a second adding unit that adds a traffic volume used by the second transmitting unit to the cumulative traffic volume.

4. The communication apparatus according to claim 3,
wherein, when a period from a latest timing at which the operation information was transmitted by the second transmitting unit to a transmission timing according to the schedule indicated by the schedule information is equal to or less than a predetermined period, the first transmitting unit does not transmit the operation information at the transmission timing.

5. The communication apparatus according to claim 3, further comprising:
an instructing unit that, when the subtraction result is less than the specified traffic volume, instructs the first transmitting unit to stop transmission of the operation information at one or more timings according to the schedule,
wherein, when the subtraction result is less than the specified traffic volume, the second transmitting unit transmits the operation information whose transmission is specified in the instruction, to the management apparatus.

6. The communication apparatus according to claim 4, further comprising:
an instructing unit that, when the subtraction result is less than the specified traffic volume, instructs the first transmitting unit to stop transmission of the operation information at one or more timings according to the schedule,
wherein, when the subtraction result is less than the specified traffic volume, the second transmitting unit transmits the operation information whose transmission is specified in the instruction, to the management apparatus.

7. The communication apparatus according to claim 5,
wherein the instructing unit specifies the number of transmissions to be stopped on a basis of the specified traffic volume, and instructs the first transmitting unit to stop transmissions of the operation information, the number of which is equal to the specified number.

8. The communication apparatus according to claim 6,
wherein the instructing unit specifies the number of transmissions to be stopped on a basis of the specified traffic volume, and instructs the first transmitting unit to stop transmissions of the operation information, the number of which is equal to the specified number.

9. The communication apparatus according to claim 3, further comprising:
a notifying unit, when the subtraction result is less than the specified traffic volume, notifies a user of a message that the transmission of the operation information is to incur an additional charge, the transmission of the operation information being specified in the instruction.

10. The communication apparatus according to claim 4, further comprising:
a notifying unit, when the subtraction result is less than the specified traffic volume, notifies a user of a message that the transmission of the operation information is to incur an additional charge, the transmission of the operation information being specified in the instruction.

11. The communication apparatus according to claim 5, further comprising:
a notifying unit, when the subtraction result is less than the specified traffic volume, notifies a user of a message that the transmission of the operation information is to incur an additional charge, the transmission of the operation information being specified in the instruction.

12. The communication apparatus according to claim 6, further comprising:
a notifying unit, when the subtraction result is less than the specified traffic volume, notifies a user of a message that the transmission of the operation information is to incur an additional charge, the transmission of the operation information being specified in the instruction.

13. The communication apparatus according to claim 7, further comprising:
a notifying unit, when the subtraction result is less than the specified traffic volume, notifies a user of a message that the transmission of the operation information is to incur an additional charge, the transmission of the operation information being specified in the instruction.

14. The communication apparatus according to claim 8, further comprising:
a notifying unit, when the subtraction result is less than the specified traffic volume, notifies a user of a message that the transmission of the operation information is to incur an additional charge, the transmission of the operation information being specified in the instruction.

15. The communication apparatus according to claim 3, further comprising:
a third transmitting unit that, when the subtraction result is less than the specified traffic volume, transmits information to the management apparatus, the information indicating that the transmission of the operation information is to incur an additional charge, the transmission of the operation information being specified in the instruction.

16. An image forming apparatus comprising:
the communication apparatus according to claim 1; and an image forming section that forms an image on a medium,
wherein the operation information includes information about an operational condition of the image forming section.

17. A non-transitory computer readable medium storing a program for causing a computer to execute a process, the computer including a first storage unit and a second storage unit, the first storage unit storing operation information about an operational condition of a communication apparatus, the second storage unit storing charge information about a charge amount according to use of a communication line, the process comprising:
communicating with the communication line for which the charge amount is changed in accordance with the use of the communication line;
permitting transmission of the operation information on a basis of a result obtained by comparing the charge information with predetermined charge limit information.
